(19) United States
(12) Patent Application Publication
(10) Pub. No.: US 2023/0325712 A1
(43) Pub. Date: Oct. 12, 2023

(54) SYSTEM AND METHOD FOR IMITATION LEARNING

(71) Applicant: ELECTRONICS AND TELECOMMUNICATIONS RESEARCH INSTITUTE, Daejeon (KR)

(72) Inventor: Jin Chul CHOI, Daejeon (KR)

(21) Appl. No.: 18/109,975

(22) Filed: Feb. 15, 2023

(30) Foreign Application Priority Data
Apr. 7, 2022 (KR) 10-2022-0043454

(51) Int. Cl. G06N 20/00

(52) U.S. Cl. CPC G06N 20/00

(57) ABSTRACT

The present disclosure relates to a system and method for imitation learning. The system for imitation learning may include a data augmentation device configured to acquire a plurality of augmented data sets from a plurality of demonstration data sets corresponding to an expert's demonstration behavior trajectory using a behavioral replication model that infers behavioral data from input state data and an inverse behavioral replication model that infers state data from input behavioral data, and an imitation learning device configured to perform imitation learning to derive a model that outputs behavioral data similar to an expert in a specific state using the plurality of demonstration data sets and the plurality of augmented data sets, in which the plurality of demonstration data sets and the plurality of augmented data sets each include a pair of corresponding state data and behavioral data.

### CROSS-REFERENCE TO RELATED APPLICATION

This application claims priority to and the benefit of Korean Patent Application No. 2022-0043454, filed on Apr. 7, 2022, the disclosure of which is incorporated herein by reference in its entirety.

### BACKGROUND

### 1. Field of the Invention

The present disclosure relates to a system and method for imitation learning, and more particularly, to a system and method for imitation learning through augmentation of experts' demonstration data.

### 2. Description of Related Art

Imitation learning is a class of machine learning techniques that performs learning to derive a behavioral policy that behaves like an expert in an arbitrary state. Specifically, the imitation learning is a learning technique that trains experts' demonstration data through deep learning when the experts' demonstration data is given to derive a model that outputs actions similar to or with little difference from the experts in a specific state.

The imitation learning is attracting attention as an alternative that may overcome the limitations of reinforcement learning, such as low sample efficiency, sophisticated reward function requirements, large learning time, and computing power. However, the imitation learning is more likely to fail in deriving a policy that imitates experts if demonstration data is insufficient, and frequently causes a problem of overfitting to specific demonstration data.

In order to overcome these limitations, a method of augmenting experts' demonstration data for learning is attracting attention. Data augmentation technology refers to a process of transforming original data labels in order to increase a label space and quantity of a dataset. Data augmentation is often used to increase the amount of image data in the field of vision artificial intelligence (AI). In general, image data augmentation techniques apply techniques, such as horizontal/vertical inversion, corner distortion, rotations, and focusing, to an original image.

However, in the imitation learning, since demonstration data of actions or tasks of experts (humans, robots, objects, etc.) to be imitated have characteristics of a series of sequential time-series data collected over a certain period of time, and a motion of a human or a robot is expressed as a multiple joint values with a wide action space or an amount of change in spatial coordinate values, it is difficult to utilize existing image data augmentation techniques as they are.

### SUMMARY OF THE INVENTION

The present disclosure provides a system and method for imitation learning capable of improving imitation learning performance using training data sets augmented from an expert's demonstration data.

According to an aspect of the present invention, a system for imitation learning may include a data augmentation device configured to acquire a plurality of augmented data sets from a plurality of demonstration data sets corresponding to an expert's demonstration behavior trajectory using a behavioral replication model that infers behavioral data from input state data and an inverse behavioral replication model that infers state data from input behavioral data, and an imitation learning device configured to perform imitation learning to derive a model that outputs behavioral data similar to an expert in a specific state using the plurality of demonstration data sets and the plurality of augmented data sets, in which the plurality of demonstration data sets and the plurality of augmented data sets each include a pair of corresponding state data and behavioral data.

When the data augmentation device inputs first state data included in each demonstration data set to the behavioral replication model and the behavioral replication model outputs first behavioral data inferred from the first state data, the data augmentation device may acquire augmented second state data by inputting the first behavioral data to the inverse behavioral replication model and acquire augmented second behavioral data by inputting the second state data to the behavioral replication model.

The system for imitation learning may further include a data augmentation model learning device configured to train the behavioral replication model and the inverse behavioral replication model using the plurality of demonstration data sets.

The behavioral replication model and the inverse behavioral replication model of the system for imitation learning may be artificial neural network-based models.

The data augmentation model learning device may train the behavioral replication model using a loss function value L_{BC} of Equation 1 below.

$${L}_{BC} = {\sum }_{( {a}_{{E}_{t}} , {a}_{t} ) ∈ A} {‖ {a}_{{E}_{t}} - {a}_{t} ‖}_{2}^{2} \qquad [ Equation 1 ]$$

Where a_{E}_{ₜ} may denote behavioral data included in the expert's demonstration data set, aₜ may denote behavioral data inferred through the behavioral replication model, and A may denote an action space that is a set of all possible actions.

The data augmentation model learning device may train the behavioral replication model using a loss function value L_{BC} of Equation 2 below.

$${L}_{IBC} = {\sum }_{( {s}_{{E}_{t}} , {s}_{t} ) ∈ S} {‖ {s}_{{E}_{t}} - {s}_{t} ‖}_{2}^{2} \qquad [ Equation 2 ]$$

Where s_{E}_{ₜ} may denote state data included in the expert's demonstration data set, Sₜ may denote state data inferred through the inverse behavioral replication model, and S may denote a state space that is a set of all possible states.

According to another aspect of the present invention, an imitation learning method of the system for imitation learning may include constructing a behavioral replication model that infers behavioral data from input state data and an inverse behavioral replication model that infers state data from input behavioral data, acquiring a plurality of augmented data sets from a plurality of demonstration data sets corresponding to an expert's demonstration behavior trajectory using the behavioral replication model and the inverse behavioral replication model, and performing imitation learning to derive a model that outputs behavioral data similar to an expert in a specific state using the plurality of demonstration data sets and the plurality of augmented data sets, in which each of the plurality of demonstration data sets and the plurality of augmented data sets may include a pair of corresponding state data and behavioral data.

The acquiring may include acquiring first behavioral data from the behavioral replication model by inputting first state data included in each demonstration data set to the behavioral replication model, acquiring augmented second state data from the inverse behavioral replication model by inputting the first behavioral data to the inverse behavioral replication model, and acquiring augmented second behavioral data from the behavioral replication model by inputting the second state data to the behavioral replication model.

The imitation learning method may further include training the behavioral replication model and the inverse behavioral replication model using the plurality of demonstration data sets.

The behavioral replication model and the inverse behavioral replication model of the system for imitation learning may be artificial neural network-based models.

The training may include training the behavioral replication model using a loss function value L_{BC} of Equation 1 below.

$${L}_{BC} = {\sum }_{( {a}_{{E}_{t}} , {a}_{t} ) ∈ A} {‖ {a}_{{E}_{t}} - {a}_{t} ‖}_{2}^{2} \qquad [ Equation 1 ]$$

Where a_{E}_{ₜ} may denote behavioral data included in the expert's demonstration data set, aₜ may denote behavioral data inferred through the behavioral replication model, and A may denote an action space that is a set of all possible actions.

The training may include training the behavioral replication model using a loss function value L_{BC} of Equation 2 below.

$${L}_{IBC} = {\sum }_{( {s}_{{E}_{t}} , {s}_{t} ) ∈ S} {‖ {s}_{{E}_{t}} - {s}_{t} ‖}_{2}^{2} \qquad [ Equation 2 ]$$

Where s_{E}_{ₜ} may denote state data included in the expert's demonstration data set, Sₜ may denote state data inferred through the inverse behavioral replication model, and S may denote a state space that is a set of all possible states.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 schematically illustrates a system for imitation learning according to an embodiment;

FIG. 2 schematically illustrates a configuration of a data augmentation model learning device according to an embodiment;

FIG. 3 schematically illustrates a configuration of a data augmentation device according to an embodiment;

FIG. 4 illustrates an example in which the data augmentation device according to the embodiment acquires an augmented data set from an expert's demonstration data set;

FIG. 5 schematically illustrates a configuration of an imitation learning device according to an embodiment; and

FIG. 6 schematically illustrates an imitation learning method according to an embodiment.

### DETAILED DESCRIPTION OF EXEMPLARY EMBODIMENTS

Hereafter, embodiments of the present disclosure will be described in detail with reference to the accompanying drawings and the same or similar components are given the same reference numerals and are not repeatedly described. In addition, terms “module” and “unit” for components used in the following description are used only to easily write the disclosure. Therefore, these terms do not have meanings or roles that distinguish from each other in themselves. Further, when it is decided that a detailed description for the known art related to the present disclosure may obscure the gist of the present disclosure, the detailed description will be omitted. Further, it should be understood that the accompanying drawings are provided only in order to allow exemplary embodiments of the present disclosure to be easily understood, and the spirit of the present disclosure is not limited by the accompanying drawings and includes all the modifications, equivalents, and substitutions included in the spirit and the scope of the present disclosure.

Terms including ordinal numbers such as “first,” “second,” and the like, may be used to describe various components. However, these components are not limited by these terms. The terms are used only to distinguish one component from another component.

Singular forms are intended to include plural forms unless the context clearly indicates otherwise.

It will be further understood that terms “include” or “have” used in the present specification specify the presence of features, numbers, steps, operations, components, parts mentioned in the present specification, or combinations thereof, but do not preclude the presence or addition of one or more other features, numbers, steps, operations, components, parts, or combinations thereof.

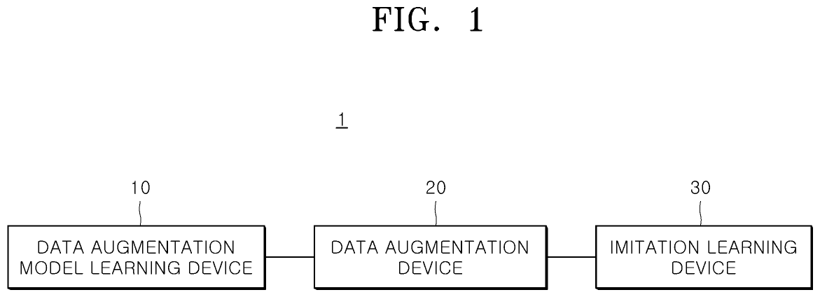

FIG. 1 schematically illustrates a system for imitation learning according to an embodiment.

Referring to FIG. 1, a system 1 for imitation learning according to the embodiment may include a data augmentation model learning device 10, a data augmentation device 20, and an imitation learning device 30.

The data augmentation model learning device 10 may generate a behavioral replication model and an inverse behavioral replication model used for augmentation of a demonstration data set through learning of an artificial neural network.

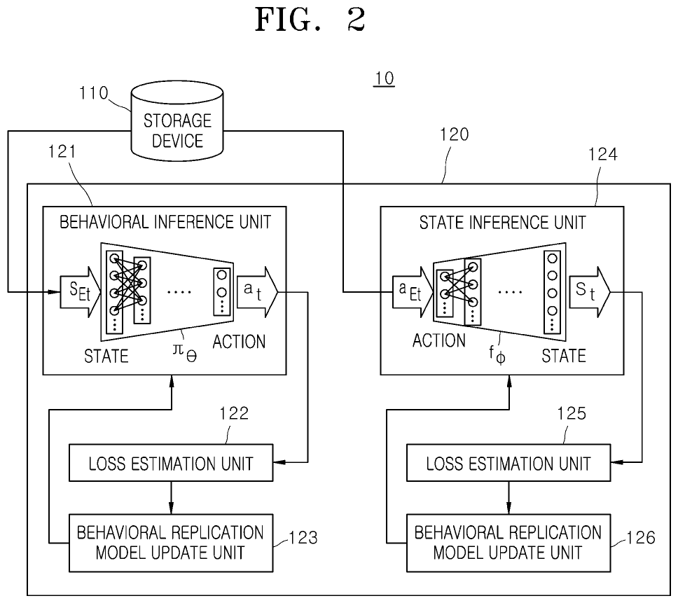

Hereinafter, a method of learning a behavioral replication model and an inverse behavioral replication model in the data augmentation model learning device 10 will be described with reference to FIG. 2.

FIG. 2 schematically illustrates a configuration of the data augmentation model learning device 10 according to an embodiment.

Referring to FIG. 2, the data augmentation model learning device 10 may include a storage device 110 and a control device 120.

The storage device 110 includes at least one memory and may store various types of data processed by the data augmentation model learning device 10. The storage device 110 may store training data sets for training a behavioral replication model π_{θ} and an inverse behavioral replication model f_{φ} to be described below. Here, the training data set used for training the behavioral replication model π_{θ} and the inverse behavioral replication model f_{φ} may be a time-series behavior trajectory data set including a pair of a state changing as an expert demonstrates a task and a corresponding expert action. That is, the training data set is an expert's demonstration data set, which represents the expert's demonstration behavior trajectory as a state s_{E}_{ₜ}-action a_{E}_{ₜ} data set over time t. Here, s_{E}_{ₜ} and a_{E}_{ₜ} may each denote the expert's state data and the behavioral data taken by the expert at time t. The storage device 110 may store the trained behavioral replication model π*_{θ} and inverse behavioral replication model f*_{φ}.

The control device 120 is constituted of at least one processor, and may perform functions of a behavioral inference unit 121, a loss estimation unit 122, and a behavioral replication model update unit 123 through the at least one processor.

The behavioral inference unit 121 may infer the behavioral data at corresponding to the input state data s_{E}_{ₜ} using the behavioral replication model π_{θ} configured based on an artificial neural network. The behavioral replication model π_{θ} is a neural network that uses the state s_{E}_{ₜ}-action a_{E}_{ₜ} data pair of the training data set (demonstration data set) to output behavioral data close to a demonstrator's action, and the input is the state data s_{E}_{ₜ} of the demonstration data set, and the output is behavioral data at inferred from the state data s_{E}_{ₜ}.

The loss estimation unit 122 may input the demonstration data sets s_{E}_{ₜ} and a_{E}_{ₜ} input to the behavioral replication model π_{θ} and the behavioral data at inferred using the demonstration data sets s_{E}_{ₜ} and a_{E}_{ₜ} in the behavioral replication model π_{θ} to the loss function of the behavioral replication model π_{θ}, thereby estimating the loss of the behavioral replication model γ_{θ}.

The loss function of the behavioral replication model π_{θ} is defined as in Equation 1 below.

$${L}_{BC} = {\sum }_{( {a}_{{E}_{t}} , {a}_{t} ) ∈ A} {‖ {a}_{{E}_{t}} - {a}_{t} ‖}_{2}^{2} \qquad [ Equation 1 ]$$

In Equation 1 above, A denotes an action space that is a set of all possible actions.

The behavioral replication model update unit 123 may update internal neural network parameters of the behavioral replication model π_{θ} so that the loss function value L_{BC} for the input demonstration data sets s_{E}_{ₜ} and a_{E}_{ₜ} is minimized. In this case, an optimization algorithm such as gradient descent may be used to update the behavioral replication model π_{θ}.

The control device 120 iterates the above-described optimization process, and when the loss function value L_{BC} reaches a threshold value specified by a user or the specified number of iterations, may terminate the training of the behavioral replication model π_{θ}, and store the trained behavioral replication model π*_{θ} in the storage device 110.

The control device 120 may further include a state inference unit 124, a loss estimation unit 125, and an inverse behavioral replication model update unit 126.

The state inference unit 124 may infer state data Sₜ corresponding to the input behavioral data a_{E}_{ₜ} using the behavioral replication model f_{φ} configured based on the artificial neural network. The inverse behavioral replication model f_{φ} is a neural network that uses a state s_{E}_{ₜ}-action a_{E}_{ₜ} data pair of the training data set (demonstration data set) to output state data of a state that causes a demonstrator's action, and the input is the behavioral data a_{E}_{ₜ} of the demonstration data set and the output is the state data Sₜ inferred from the behavioral data a_{E}_{ₜ}.

The loss estimation unit 125 may input the demonstration data sets s_{E}_{ₜ} and a_{E}_{ₜ} input to the inverse behavioral replication model f_{φ} and the state data Sₜ inferred using the demonstration data sets s_{E}_{ₜ} and a_{E}_{ₜ} in the inverse behavioral replication model f_{φ} to the loss function of the inverse behavioral replication model f_{φ}, thereby estimating the loss of the inverse behavioral replication model f_{φ}.

The loss function of the inverse behavioral replication model f_{φ} is defined as in Equation 2 below.

$${L}_{IBC} = {\sum }_{( {s}_{{E}_{t}} , {s}_{t} ) ∈ S} {‖ {s}_{{E}_{t}} - {s}_{t} ‖}_{2}^{2} \qquad [ Equation 2 ]$$

In Equation 2 above, S denotes the action space that is a set of all possible states.

The inverse behavioral replication model update unit 126 may update the internal neural network parameters of the inverse behavioral replication model f_{φ} so that the loss function value L_{BC} for the input demonstration data sets s_{E}_{ₜ} and a_{E}_{ₜ} is minimized. In this case, an optimization algorithm such as gradient descent may be used to update the inverse behavioral replication model f_{φ}.

The control device 120 iterates the above-described optimization process, and when the loss function value L_{BC} reaches a threshold value specified by a user or the specified number of iterations, may terminate the training of the inverse behavioral replication model f_{φ}, and store the trained inverse behavioral replication model f*_{φ} in the storage device 110.

Referring back to FIG. 1, the data augmentation device 20 may use the behavioral replication model π*_{φ} and the inverse behavioral replication model f*_{φ} trained by the data augmentation model learning device 10 to derive a new data set from the expert's demonstration data set, that is, a new state-behavioral data pair different from the expert's state and action. As discussed above, the behavioral replication model π*_{θ} is a model that receives state data and outputs behavioral data, and conversely, the inverse behavioral replication model f*_{φ} is a model that receives behavioral data and outputs state data.

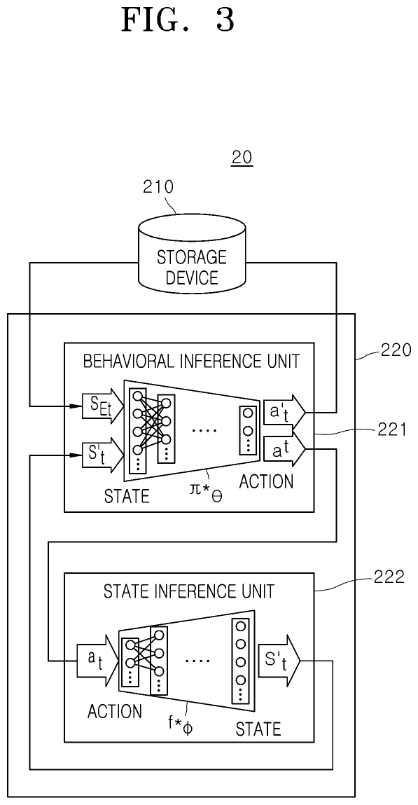

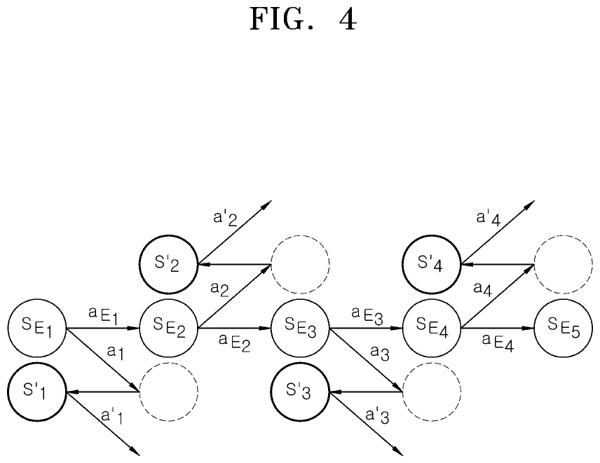

Hereinafter, a method of augmenting a demonstration data set in the data augmentation device 20 will be described with reference to FIGS. 3 and 4.

FIG. 3 schematically illustrates the configuration of the data augmentation device 20 according to an embodiment.

Referring to FIG. 3, the data augmentation device 20 may include a storage device 210 and a control device 220.

The storage device 210 includes at least one memory and may store various types of data processed by the data augmentation device 20. The storage device 210 may store an expert's demonstration data set (state s_{E}_{ₜ}-action a_{E}_{ₜ} data pair) to be used for data augmentation.

The control device 220 is constituted of at least one processor, and may derive a new state-behavioral data pair different from the expert's state and action using the behavioral replication model π*_{θ} and the inverse behavioral replication model f*_{φ}. The control device 220 may perform functions of a behavioral inference unit 221 that outputs behavioral data inferred from the input state data using the behavioral replication model π*_{θ} through at least one processor, and a state inference unit 222 that outputs state data inferred from the input behavioral data using the inverse behavioral replication model f*_{φ}.

FIG. 4 illustrates an example of acquiring an augmented data set from the expert's demonstration data set in the control device 220 of the data augmentation device 20 according to an embodiment.

In FIG. 4, s_{E}_{ₜ} and a_{E}_{ₜ} are state-behavioral data included in the expert's demonstration data set, and denote the expert's state data and the expert's behavioral data at time t, respectively.

The expert's demonstration data set may include a series of successive state-behavioral data pairs from an initial state to a final state s_{E}_{₅} by an iterative process of determining an action according to a state such as changing from initial state s_{E}_{₁} to state s_{E}_{₂} by taking action a_{E}_{₁} and changing to s_{E}_{₃} by taking action a_{E}_{₂} again.

Referring to FIG. 4, the behavioral inference unit 221 may input the state data s_{E}_{₁} to the behavioral replication model π*_{θ} when expert demonstration data set is input, and the behavioral replication model π*_{θ} may output the behavioral data a₁ inferred from the input state data s_{E}_{ₜ}.

The state inference unit 222 may input the behavioral data a₁ output from the behavioral replication model π*_{θ} of the behavioral inference unit 221 to the inverse behavioral replication model f*_{φ}, and the inverse behavioral replication model f*_{φ} may output state data S′₁ inferred from the input behavioral data a₁.

Thereafter, the behavioral inference unit 221 again inputs the state data S′₁ output from the inverse behavioral replication model f*_{θ} to the behavioral replication model π*_{θ}, and the behavioral replication model π*_{θ} outputs new behavioral data a′₁ from the input state data S′₁.

As described above, the control device 220 may use the behavioral replication model π*_{θ} and the inverse behavioral replication model f*_{θ} to acquire a new data set (state-behavioral data pair S′₁ and a′₁) from the expert's demonstration data set (state-behavioral data pair s_{E}_{ₜ} and a_{E}_{ₜ}).

Accordingly, the control device 220 may augment a new data pair S′ₜ and a′ₜ to be used for imitation learning by applying the above-described method to each expert's state-behavioral data pair s_{E}_{ₜ} and a_{E}_{ₜ}.

When the augmented data set S′ₜ and a′ₜ is acquired through the above-described method, the control device 220 may store the acquired augmented data set S′ₜ and a′ₜ in the storage device 210.

Referring back to FIG. 1, the imitation learning device 30 may use the augmented training data set (expert's demonstration data set s_{E}_{ₜ} and a_{E}_{ₜ}) and the augmented data set S′ₜ and a′ₜ from the augmented training data set to train the behavioral replication model π_{θ}.

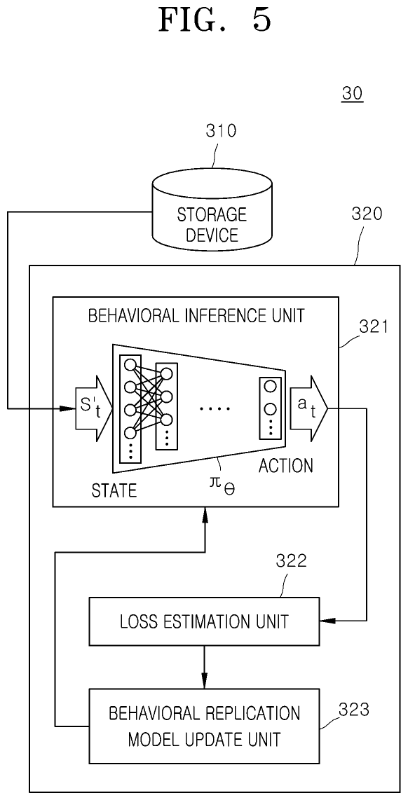

Hereinafter, referring to FIG. 5, a method of performing imitation learning using an augmented training data set in the imitation learning device 30 will be described.

FIG. 5 schematically illustrates the configuration of the imitation learning device 30 according to an embodiment.

Referring to FIG. 5, the imitation learning device 30 may include a storage device 310 and a control device 320.

The storage device 310 may store various types of data processed by the imitation learning device 30. The storage device 310 may store the training data sets used for imitation learning, that is, the expert's demonstration data set s_{E}_{ₜ} and a_{E}_{ₜ} and the augmented data set S′ₜ and a′ₜ from the expert's demonstration data set.

The control device 320 is constituted of at least one processor, and may perform functions of a behavioral inference unit 321, a loss estimation unit 322, and a behavioral replication model update unit 323 through the at least one processor.

The behavioral inference unit 321 may infer the behavioral data at corresponding to the input state data (e.g., augmented data S′ₜ) using the behavioral replication model π_{θ} configured based on the artificial neural network.

The loss estimation unit 322 may infer the loss of the behavioral replication model π_{θ} by inputting the training data set (e.g., augmented data set S′ₜ and a′ₜ) and inputting the behavioral data at inferred using the training data set in the behavior replication model π_{θ} to the loss function (refer to the above Equation 1) of the behavioral replication model γ_{θ}.

The behavioral replication model update unit 323 may update the internal neural network parameters of the behavioral replication model π_{θ} so that the loss function value L_{BC} for the training data set is minimized.

The control device 320 iterates the above-described optimization process, and when the loss function value L_{BC} reaches a threshold value specified by a user or the specified number of iterations, may terminate the training of the behavioral replication model π_{θ}, and store the trained behavioral replication model in the storage device 310.

The imitation learning device 30 may train the behavioral replication model π_{θ} using the augmented training data set as described above to improve the performance of the behavioral replication model that infers an action similar to an expert in a specific state.

As described above, the augmented demonstration data sets may be also applied to the existing imitation learning techniques such as generative adversarial imitation learning (GAIL) or goal-conditioned imitation learning (goalGAIL) to improve imitation learning performance.

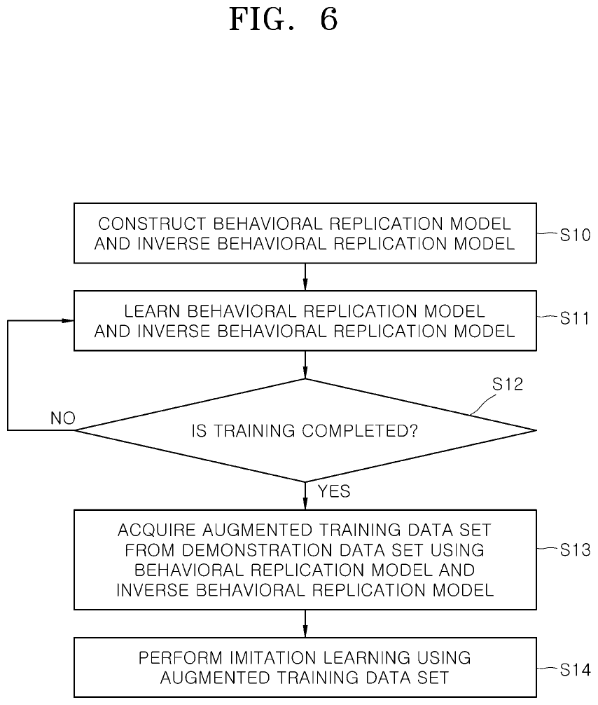

FIG. 6 schematically illustrates an imitation learning method according to an embodiment. The imitation learning method of FIG. 6 may be performed by the system for imitation learning described with reference to FIGS. 1 to 5.

Referring to FIG. 6, the data augmentation model learning device 10 constructs an artificial neural network-based behavioral replication model and an inverse behavioral replication model (S10), and uses training data sets to train the behavioral replication model and the inverse behavioral replication model (S11).

In step S10, the behavioral replication model is a neural network configured to output behavioral data that is inferred to be close to a demonstrator's action using an expert's demonstration data set, and when the state data of the demonstration data set is input, may output the behavioral data inferred from the state data of the demonstration data. The inverse behavioral replication model is a neural network configured to output state data that is inferred to have caused the demonstrator's action using the expert's demonstration data set, and when the behavioral data of the demonstration data set is input, may output state data inferred from the behavioral data of the demonstration data set.

In step S11, the training datasets used for training the behavioral replication model and the inverse behavioral replication model are the expert's demonstration data set, which represents the expert's demonstration behavior trajectory as a state-behavioral data pair over time t.

In step S11, the data augmentation model learning device 10 may train the behavioral replication model and the inverse behavioral replication model by a method of calculating loss functions (see Equations 1 and 2 above) of a behavioral replication model and an inverse behavioral replication model, respectively, and updating neural network parameters inside the behavioral replication model and the inverse behavioral replication model, respectively, so that the calculated loss function value is minimized.

When the training of the behavioral replication model and the inverse behavioral replication model is completed by the data augmentation model learning device 10 (S12), the data augmentation device 20 may acquire the augmented training data set from the expert's demonstration data set using the trained behavioral replication model and inverse behavioral replication model (S13).

In step S12, the data augmentation model learning device 10 may process each model as having been trained when the values of the loss functions of each model reach the specified threshold value or the number of times of training of each model reaches the specified number of times of iterations.

In step S13, the data augmentation device 20 may input the state data into the behavioral replication model when the expert's demonstration data set is input, and when the behavioral replication model outputs the behavioral data inferred from the input state data, input the behavioral data to the inverse behavioral replication model, thereby acquiring new state data. Then, the data augmentation device 20 may acquire new behavioral data corresponding to new state data by inputting the acquired new state data to the behavioral replication model again. In this way, the data augmentation device 20 may acquire the augmented data set (state-behavioral data pair) from the expert's demonstration data set using the trained behavioral replication model and inverse behavioral replication model through step S11.

Thereafter, the imitation learning device 30 may perform the imitation learning using the augmented training data set acquired through step S13 (S14). In step S14, the imitation learning device 30 may perform imitation learning to derive a model that outputs behavioral data similar to an expert in a specific state by learning a behavioral policy by a deep learning method using the augmented training data sets.

Embodiments of the present invention are not implemented only through the devices and/or methods described above, and may be implemented through a program that realizes functions corresponding to the configuration of the embodiments of the present invention or a recording medium in which the program is recorded. Such an implementation can be easily implemented by those skilled in the art to which the present invention pertains based on the description of the above-described embodiment.

According to the present disclosure, it is possible to augment the amount of training data set to be used for imitation learning. In addition, according to the present disclosure, by providing training data about states and actions that are not included in an expert's demonstration, it is possible to provide flexible actions even for states that are not provided by the expert's demonstration to improve learning performance.

Although embodiments of the present invention have been described in detail hereinabove, the scope of the present invention is not limited thereto and may include several modifications and alterations made by those skilled in the art using a basic concept of the present invention as defined in the claims.

What is claimed is:

1. A system for imitation learning, comprising:
a data augmentation device configured to acquire a plurality of augmented data sets from a plurality of demonstration data sets corresponding to an expert's demonstration behavior trajectory using a behavioral replication model that infers behavioral data from input state data and an inverse behavioral replication model that infers state data from input behavioral data; and
an imitation learning device configured to perform imitation learning to derive a model that outputs behavioral data similar to the expert in a specific state using the plurality of demonstration data sets and the plurality of augmented data sets,
wherein the plurality of demonstration data sets and the plurality of augmented data sets each include a pair of corresponding state data and behavioral data.

2. The system of claim 1, wherein, when the data augmentation device inputs first state data included in each demonstration data set to the behavioral replication model and the behavioral replication model outputs first behavioral data inferred from the first state data, the data augmentation device acquires augmented second state data by inputting the first behavioral data to the inverse behavioral replication model and acquires augmented second behavioral data by inputting the second state data to the behavioral replication model.

3. The system of claim 1, further comprising a data augmentation model learning device configured to train the behavioral replication model and the inverse behavioral replication model using the plurality of demonstration data sets.

4. The system of claim 3, wherein the behavioral replication model and the inverse behavioral replication model are artificial neural network-based models.

5. The system of claim 3, wherein the data augmentation model learning device trains the behavioral replication model using a loss function value L_{BC} of Equation 1 below,
$${L}_{BC} = {\sum }_{( {a}_{{E}_{t}} , {a}_{t} ) ∈ A} {‖ {a}_{{E}_{t}} - {a}_{t} ‖}_{2}^{2} , \qquad [ Equation 1 ]$$
where a_{E}_{ₜ} denotes behavioral data included in an expert's demonstration data set, aₜ denotes behavioral data inferred through the behavioral replication model, and A denotes an action space that is a set of all possible actions.

6. The system of claim 3, wherein the data augmentation model learning device trains the inverse behavioral replication model using a loss function value L_{IBC} of Equation 2 below,
$${L}_{IBC} = {\sum }_{( {s}_{{E}_{t}} , {s}_{t} ) ∈ S} {‖ {s}_{{E}_{t}} - {s}_{t} ‖}_{2}^{2} \qquad [ Equation 2 ]$$
where s_{E}_{ₜ} denotes state data included in an expert's demonstration data set, sₜ is state data inferred through the inverse behavioral replication model, and S denotes a state space that is a set of all possible states.

7. An imitation learning method of an imitation learning device, the method comprising:
constructing a behavioral replication model that infers behavioral data from input state data and an inverse behavioral replication model that infers state data from input behavioral data;
acquiring a plurality of augmented data sets from a plurality of demonstration data sets corresponding to an expert's demonstration behavior trajectory using the behavioral replication model and the inverse behavioral replication model; and
performing imitation learning to derive a model that outputs behavioral data similar to an expert in a specific state using the plurality of demonstration data sets and the plurality of augmented data sets,
wherein each of the plurality of demonstration data sets and the plurality of augmented data sets includes a pair of corresponding state data and behavioral data.

8. The method of claim 7, wherein the acquiring includes:
acquiring first behavioral data from the behavioral replication model by inputting first state data included in each demonstration data set to the behavioral replication model;
acquiring augmented second state data from the inverse behavioral replication model by inputting the first behavioral data to the inverse behavioral replication model; and
acquiring augmented second behavioral data from the behavioral replication model by inputting the second state data to the behavioral replication model.

9. The method of claim 7, further comprising training the behavioral replication model and the inverse behavioral replication model using the plurality of demonstration data sets.

10. The method of claim 9, wherein the behavioral replication model and the inverse behavioral replication model are artificial neural network-based models.

11. The method of claim 9, wherein the training includes training the behavioral replication model using a loss function value L_{BC} of Equation 1 below,
$${L}_{BC} = {\sum }_{( {a}_{{E}_{t}} , {a}_{t} ) ∈ A} {‖ {a}_{{E}_{t}} - {a}_{t} ‖}_{2}^{2} , \qquad [ Equation 1 ]$$
where a_{E}_{ₜ} denotes behavioral data included in the expert's demonstration data set, aₜ denotes behavioral data inferred through the behavioral replication model, and A denotes an action space that is a set of all possible actions.

12. The method of claim 9, wherein the learning includes training the inverse behavioral replication model using a loss function value L_{IBC} of Equation 2 below,
$${L}_{IBC} = {\sum }_{( {s}_{{E}_{t}} , {s}_{t} ) ∈ S} {‖ {s}_{{E}_{t}} - {s}_{t} ‖}_{2}^{2} , \qquad [ Equation 2 ]$$
where s_{E}_{ₜ} denotes state data included in the expert's demonstration data set, sₜ denotes state data inferred through the inverse behavioral replication model, and S denotes a state space that is a set of all possible states.
